(19) United States
(12) Patent Application Publication
(10) Pub. No.: US 2011/0053421 A1
(43) Pub. Date: Mar. 3, 2011

(54) ELECTRICAL CONNECTOR FOR TERMINATING THE END OF AN ELECTRICAL CABLE

(76) Inventors: MATTHEW EDWARD MOSTOLLER, HUMMELSTOWN, PA (US); CHRISTOPHER GEORGE DAILY, HARRISBURG, PA (US); JACOB M. DYER, MARYSVILLE, PA (US)

(21) Appl. No.: 12/551,322

(22) Filed: Aug. 31, 2009

(51) Int. Cl. H01R 13/40

(52) U.S. Cl. 439/625

(57) ABSTRACT

A connector and armored cable assembly includes an armored cable having an electrical wire, and a connector. The connector includes a connector housing having a mating interface. The connector housing is configured to mate with a mating connector along the mating interface. The mating interface is a separable interface such that the connector housing is separable from the mating connector at the mating interface after the connector housing and the mating connector have been mated together. A connector contact is held by the connector housing. The connector contact is configured to engage a mating contact of the mating connector. The connector contact is electrically connected to the electrical wire of the armored cable.

### BACKGROUND OF THE INVENTION

The subject matter described and/or illustrated herein relates generally to electrical connectors, and, more particularly, to electrical connectors that terminate the end of electrical cables.

Electrical cables are used to interconnect a wide variety of electrical components and come in a variety of sizes, materials, and types. Electrical cables generally include one or more electrical conductors and a protective jacket surrounding the electrical conductors. The electrical conductors are typically each surrounded by insulation to electrically insulate the conductors from each other, although some electrical cables include one or more uninsulated conductors for a circuit neutral and/or ground connection. The protective jacket of some electrical cables is armored to protect the electrical conductors from, for example, water, oil, sunlight, underground conditions, chemical vapors, mechanical impact, high and/or low temperatures, ionizing radiation, and/or the like. The armored jacket is typically constructed from metal, but may sometimes be fabricated from plastic or other materials. Examples of metal armored jackets include metal conduits or tubes that surround the electrical conductors, metal wires that are spiraled around the electrical conductors, metal tape that is wrapped around the electrical conductors, and/or the like. The metal conduits, tubes, wires, and tape may be corrugated to impart at least some flexibility to the armored jacket. Electrical cables having armored jackets are sometimes referred to as “armored cables”.

Armored cables are hardwired to the electrical components that the armored cable interconnects. Moreover, one or more of the electrical components are sometimes located in spaces that may be difficult to access, such as, but not limited to, the space between two walls of a building, the space between a ceiling and a floor of the building, and/or underneath the ground, a walkway, a driveway, a road, and/or the like. For example, armored cables are often used to interconnect light fixtures to a junction box of an electrical distribution system. Junction boxes are often mounted within spaces that may be difficult to access, such as, but not limited to, the space between two walls of a building, the space between a ceiling and a floor of the building, or underneath the ground, a walkway, a driveway, a road, and/or the like. It may therefore be difficult or impossible to access the electrical component once the ceiling, wall, or floor is finished without damaging a portion of the ceiling, wall, or floor. Similarly, once buried, it may be difficult or impossible to access the electrical component without digging up the ground, walkway, road, or driveway. The electrical component may therefore need to be hardwired to the armored cable before the ceiling, floor, wall, walkway, road, or driveway is finished, which may increase a difficulty, cost, and/or inconvenience of installing the electrical component. Moreover, it may be difficult or impossible to change or replace an existing electrical component that has been hardwired to the armored cable without removing or damaging a portion of the ceiling, wall, or floor, or without digging up the ground, walkway, road, or driveway. Furthermore, electrical components that are hardwired to armored cables may need to be installed by a licensed electrician, which may increase a cost and/or inconvenience of installing the electrical component.

### BRIEF DESCRIPTION OF THE INVENTION

In one embodiment, a connector and armored cable assembly includes an armored cable having an electrical wire, and a connector. The connector includes a connector housing having a mating interface. The connector housing is configured to mate with a mating connector along the mating interface. The mating interface is a separable interface such that the connector housing is separable from the mating connector at the mating interface after the connector housing and the mating connector have been mated together. A connector contact is held by the connector housing. The connector contact is configured to engage a mating contact of the mating connector. The connector contact is electrically connected to the electrical wire of the armored cable.

In another embodiment, a connector is provided for terminating the end of an electrical wire. The connector includes a cover and a housing held by the cover. The housing includes a mating interface configured to mate with a mating connector. The housing is rotatably held by the cover such that the housing is rotatable about an axis of rotation relative to the cover. The connector also includes a connector contact held by the housing. The connector contact is configured to engage a mating contact of the mating connector. The connector contact is configured to terminate the end of the electrical wire.

### BRIEF DESCRIPTION OF THE DRAWINGS

FIG. 1 is a perspective view of an exemplary embodiment of a light fixture and junction box system.

FIG. 2 is a partially exploded perspective view of the light fixture and junction box system shown in FIG. 1.

FIG. 3 is a perspective view of an exemplary embodiment of a cable connector and an exemplary embodiment of an electrical cable of the light fixture and junction box system shown in FIGS. 1 and 2.

FIG. 4 is an exploded perspective view of the cable connector and electrical cable shown in FIG. 3.

FIG. 5 is a partially exploded perspective view of a portion of the cable connector shown in FIGS. 3 and 4.

FIG. 6 is a front perspective view of an exemplary embodiment of a mating connector of the light fixture and junction box system shown in FIGS. 1 and 2.

FIG. 7 is a rear perspective view of the mating connector shown in FIG. 6.

### DETAILED DESCRIPTION OF THE INVENTION

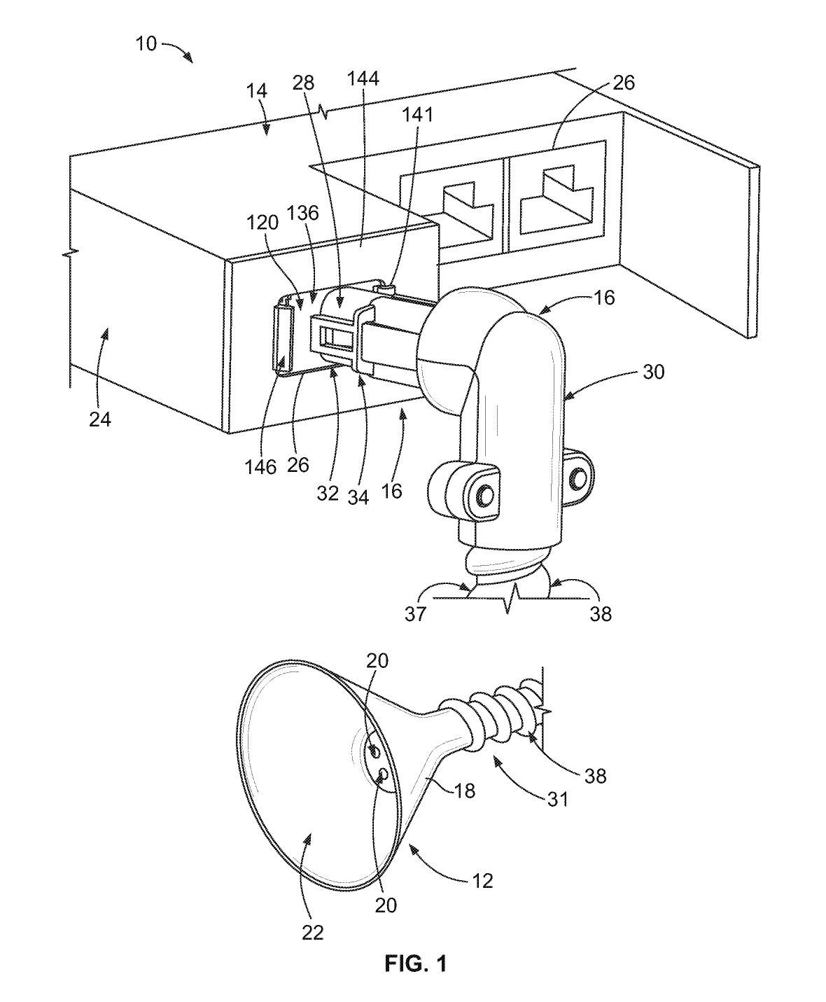

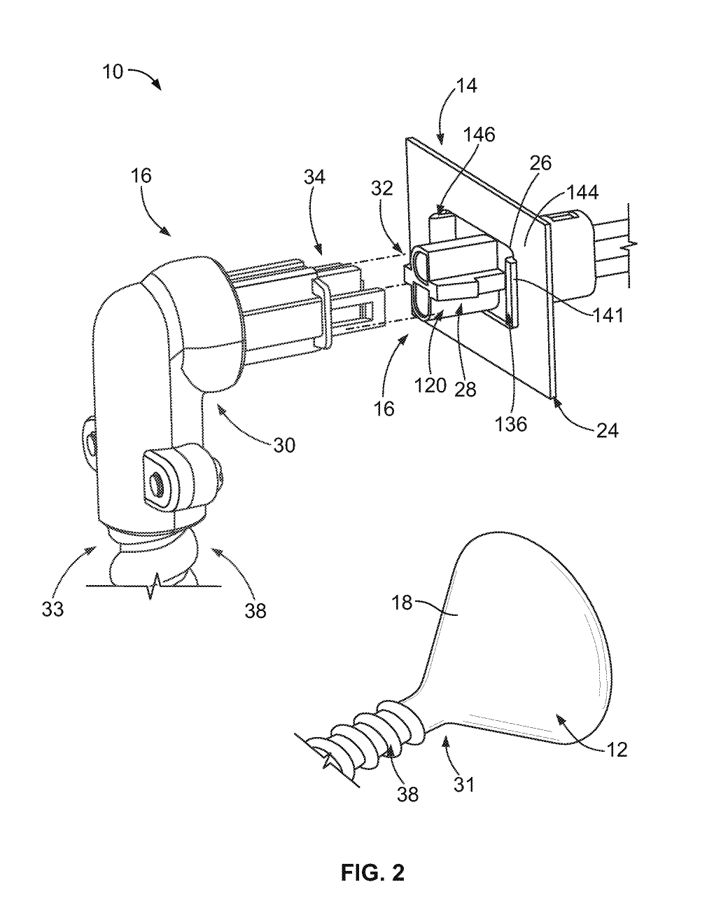

FIG. 1 is a perspective view of an exemplary embodiment of a light fixture and junction box system 10. FIG. 2 is a partially exploded perspective view of the light fixture and junction box system 10. The system 10 includes a light fixture 12, a junction box 14, a connector assembly 16, and an electrical cable 38. As will be described below, the connector assembly 16 and the electrical cable 38 electrically connect the light fixture 12 to the junction box 14 for supplying electrical power from the junction box 14 to the light fixture 12.

The light fixture 12 includes a fixture housing 18 and a pair of fixture contacts 20 (not visible in FIG. 2). The fixture housing 18 is configured to hold any source (not shown) of artificial light or illumination, such as, but not limited to, a light bulb, a light emitting diode (LED), and/or the like. The source of artificial light or illumination may be referred to herein as a “light source”. The fixture housing 18 holds the light source such that the light source is electrically connected to the fixture contacts 20 for receiving electrical power therefrom. For example, the light source may include one or more electrical contacts (not shown) that engage a corresponding one of the fixture contacts 20 when the light source is held by the fixture housing 18. In the exemplary embodiment, the fixture housing 18 defines a receptacle 22 (not visible in FIG. 2) and the fixture housing 18 is configured to hold the light source within the receptacle 22. However, the fixture housing 18 may hold the light source in any configuration, arrangement, geometry, orientation, manner, at any location of the fixture housing 18, and/or the like that enables the light source to emit artificial light or illumination. Moreover, the fixture housing 18 may hold the light source using any structure, fastener, means, connector, and/or the like, such as, but not limited to, using a threaded fastener, a clip, a snap-fit connection, and interference-fit connection, and/or the like. Although two fixture contacts 20 are shown, the fixture housing 18 may hold any number of fixture contacts 20.

The light fixture 12 may be any type of light fixture, such as, but not limited to a fixed light fixture, a free-standing or portable light fixture, and/or the like. As used herein the term “fixed light fixture” is intended to mean a light fixture that is configured to be fixedly and securely mounted on a support structure, such as, but not limited to, a ceiling, a wall, a floor, the ground, a walkway, a driveway, a road, a bridge, concrete, asphalt, blacktop, and/or the like. In the exemplary embodiment, the light fixture 12 is a fixed light fixture that is configured to be mounted on a ceiling, a wall, or a floor of a building (not shown) in a recessed manner. Alternatively the light fixture is not a recessed light fixture. Although shown as having a conical shape, the fixture housing 18 may additionally or alternatively include any other shape(s). The light fixture 12 optionally includes other components, such as, but not limited to, a reflector (not shown), an electrical ballast (not shown), an LED driver assembly (not shown), and/or the like.

The junction box 14 includes a housing 24 that holds electrical components (not shown), such as, but not limited to, electrical contacts, electrical switches, electrical fuses, LED driver components, and/or the like. The housing 24 includes one or more openings 26 for holding one or more electrical connectors, such as, but not limited to, a mating connector 28 of the connector assembly 16. The junction box 14 may form a portion of a power distribution system (not shown) of a building (not shown) or an outdoor area (not shown). One or more of the electrical components of the junction box 14 is electrically connected to an electrical power source (not shown) of the electrical power distribution system.

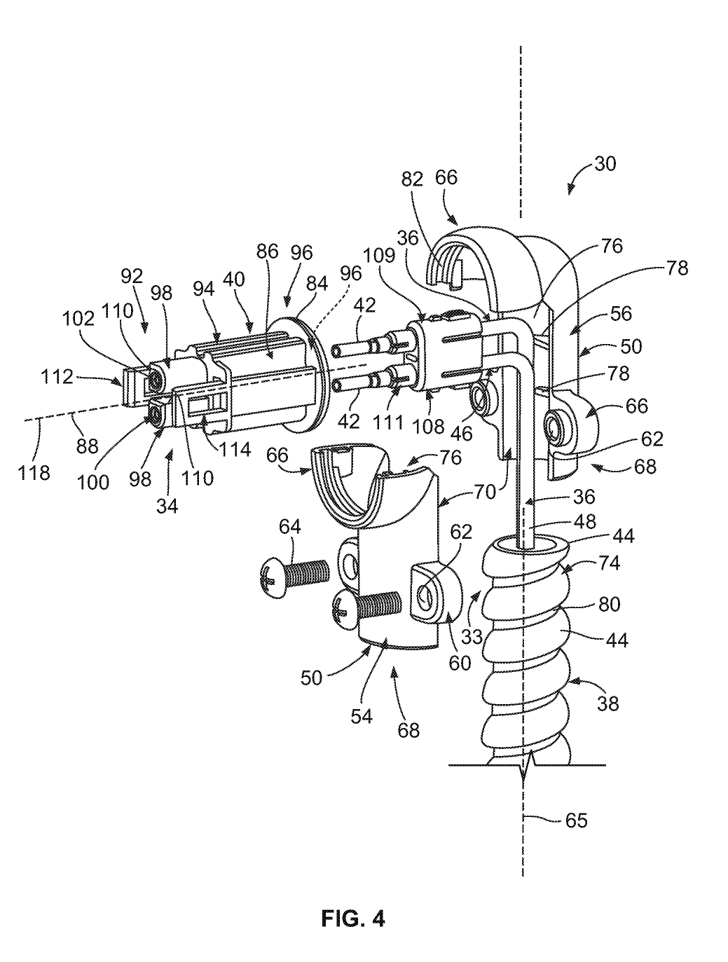

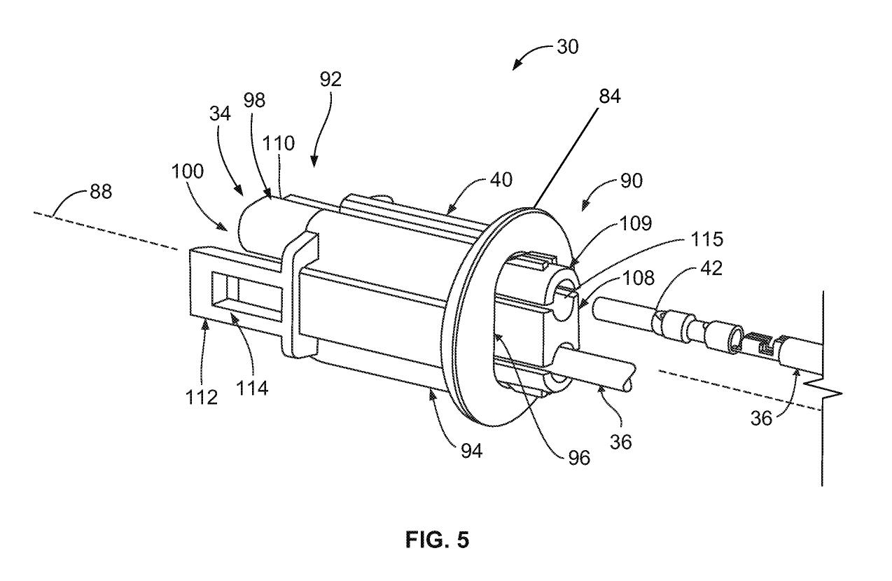

The connector assembly 16 includes the mating connector 28 and a cable connector 30. In the exemplary embodiment, the light fixture 12 is hardwired to an end 31 of the electrical cable 38, while the cable connector 30 terminates an opposite end 33 of the electrical cable 38. Specifically, in the exemplary embodiment a plurality of electrical wires 36 (FIGS. 4 and 5) of the electrical cable 38 are electrically connected to the fixture contacts 20 of the light fixture 12 at the end 31 of the electrical cable 38. At the end 33, the electrical wires 36 are terminated by the cable connector 30. The mating connector 28 is electrically connected to one or more electrical components of the junction box 14. The mating connector 28 and the cable connector 30 are configured to be mated together, as shown in FIG. 1, along respective mating interfaces 32 and 34. The ends 31 and 33 may each be referred to herein as a “cable end”.

When mated together, the connectors 28 and 30 are electrically connected together to electrically connect the light fixture 12 to the junction box 14 via the electrical cable 38. Specifically, when the mating connector 28 is mated with the cable connector 30, the connector assembly 16, via the electrical cable 38, electrically connects the fixture contacts 20 of the light fixture 12 to the electrical component(s) of the junction box 14 that the mating connector 28 is electrically connected to. Electrical power from the electrical power source of the electrical power distribution system can thereby be supplied to the light fixture 12 via the junction box 14, the connector assembly 16, and the electrical cable 38.

The connectors 28 and 30 are separable at the mating interfaces 32 and 34 such that the connectors 28 and 30 provide a separable interface between the electrical cable 38 and the junction box 14. The connectors 28 and 30 thereby provide a separable interface between the light fixture 12 and the junction box 14. In addition or alternative to the separable interface between the electrical cable 38 and the junction box 14 provided by the connector assembly 16, a separable interface between the end 31 of the electrical cable 38 and the light fixture 12 may be provided using a connector assembly (not shown) that is substantially similar to the connector assembly 16. Specifically, the end 31 of the electrical cable 38 may be terminated by a connector (not shown) that is substantially similar to the cable connector 30 or the mating connector 28, with the fixture contacts 20 of the light fixture 12 being electrically connected to a connector (not shown) that is substantially similar to the mating connector 28 or the cable connector 30. The connector that optionally terminates the end 31 of the electrical cable 38 mates with the optional connector that is electrically connected to the fixture contacts 20 along a separable interface. The optional connector that is electrically connected to the fixture contacts 20 may or may not be held by the fixture housing 18.

In the exemplary embodiment, the mating connector 28 is held by the housing 24 of the junction box 14. Alternatively, the mating connector 28 is not held by the housing 24 of the junction box 14 but rather is mechanically connected to the junction box 14 via one or more electrical wires, which may or may not be grouped in an electrical cable, such as, but not limited to, an armored cable and/or the like. Moreover, in an alternative embodiment the cable connector 30 is electrically connected to one or more of the electrical components of the junction box 14 and the mating connector 28 terminates the end 33 of the electrical cable 38.

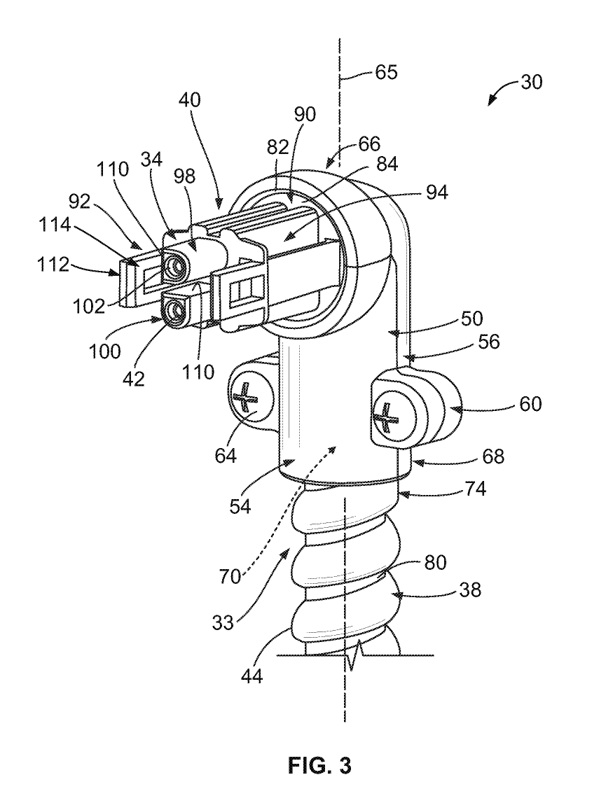

FIG. 3 is a perspective view of an exemplary embodiment of the cable connector 30 and an exemplary embodiment of the electrical cable 38 illustrating the cable connector 30 terminating the end 33 of the electrical cable 38. FIG. 4 is an exploded perspective view of the cable connector 30 and the electrical cable 38. In the exemplary embodiment, the cable connector 30 includes a connector housing 40, a pair of connector contacts 42, and a cover 50. The electrical cable 38, in the exemplary embodiment, includes the electrical wires 36 (not visible in FIG. 3) and an armored jacket 44 surrounding the electrical wires 36. Each electrical wire 36 extends from an end 46 (not visible in FIG. 3) that is terminated by, and thus electrically connected to, a corresponding one of the connector contacts 42 and an opposite end (not shown) that is terminated by, and thus electrically connected to, a corresponding one of the fixture contacts 20 (FIGS. 1 and 2).

In the exemplary embodiment, the jacket 44 is armored to protect the electrical wires 36 from, for example, water, oil, sunlight, underground conditions, chemical vapors, mechanical impact, high and/or low temperatures, ionizing radiation, and/or the like. The armored jacket 44 is constructed from metal in the exemplary embodiment, but may alternatively be fabricated from a plastic, any other non-metallic materials, and/or the like. In the exemplary embodiment, the armored jacket 44 is a metal conduit, or tube, that surrounds the electrical wires 36. Alternatively, the armored jacket 44 is fabricated from metal wires that are spiraled around the electrical wires 36, metal tape that is wrapped around the electrical wires 36, and/or the like. The armored jacket 44 is optionally corrugated, which may impart at least some flexibility to the armored jacket 44. The electrical cable 38 may be referred to herein as an “armored cable”. In alternative embodiments, the armored jacket 44 may be any other type of jacket fabricated from any material(s), such as, but not limited to, a jacket fabricated from an electrically and/or thermally insulating material, and/or the like. In some alternative embodiments, the electrical cable 38 is not armored. Moreover, in an alternative embodiment, the electrical wires 36 are not grouped together in the electrical cable 38, such that the jacket 44 is not included. In the exemplary embodiment, each electrical wire 36 includes one or more strands of an electrical conductor (not shown) that is surrounded by an insulating layer 48 (not visible in FIG. 3). Alternatively, one or more of the electrical wires 36 may not include the insulating layer 48. For example, the electrical cable 38 may include one or more uninsulated electrical wires 36 for a circuit neutral and/or ground connection (although circuit neutral and ground connections may also be provided by the electrical cable 38 using insulated electrical wires 36). Although two electrical wires 36 and two connector contacts 42 are shown, the cable connector 30 may include any number of connector contacts 42 for terminating any number of electrical wires 36.

As will be described below, the connector housing 40 is rotatably held by the cover 50 for rotation relative to the cover 50. In the exemplary embodiment, the cover 50 includes a pair of cover members 54 and 56 that connect together to define the cover 50. Alternatively the cover 50 is defined by only a single cover member, or by more than two cover members that connect together to define the cover 50. In the exemplary embodiment, the cover members 54 and 56 each include one or more mounting ears 60 having openings 62 (not visible in FIG. 3) that receive threaded fasteners 64 for connecting the cover members 54 and 56 together. In addition or alternative to the mounting ears 60, the openings 62, and/or the threaded fasteners 64, the cover members 54 and 56 may be connected together using any other type of arrangement, structure, means, connection type, fasteners, and/or the like, such as, but not limited to, a snap-fit, an interference fit, using a clip, using a latch, and/or the like.

The cover 50 extends a length along a central longitudinal axis 65. A cavity 70 extends within the cover 50. A portion of the end 33 of the cable 38 is held within the cavity 70 such that a portion of each of the electrical wires 36 extends, and is therefore held, within the cavity 70. Specifically, in the exemplary embodiment, an end 74 of the armored jacket 44 is received within the cavity 70 through an end 68 of the cover 50 and is mechanically connected to the cover 50 to hold the electrical cable 38 to the cover 50. In the exemplary embodiment, an interior surface 76 (not visible in FIG. 3) of the cover 50 includes one or more extensions 78 that extend outwardly from the surface for reception within a corresponding groove 80 of the armored jacket 44. Reception of the extensions 78 within the grooves 80 facilitates holding the armored 44, and thus the electrical cable 38, to the cover 50. An end 66 of the cover 50 includes a groove 82 within the interior surface 76 of the cover 50 for receiving a flange 84 of the connector housing 40 for holding the connector housing 40 to the cover 50, as will be described below.

FIG. 5 is a partially exploded perspective view of a portion of the cable connector 30 illustrating the connector housing 40, one of the connector contacts 42, and the electrical wires 36. Referring now to FIGS. 3-5, the connector housing 40 extends outwardly from the end 66 (not shown in FIG. 5) of the cover 50 (not shown in FIG. 5). The connector housing 40 extends a length along a central longitudinal axis 88 (not shown in FIG. 3) from an end 90 to an opposite end 92. The mating interface 34 of the cable connector 30 includes the end 90 of the connector housing 40. The connector housing 40 is configured to separabely mate with the mating connector 28 (FIGS. 1, 6, and 7) at the mating interface 34. The connector housing 40 includes a base 94, which includes the end 90. The base 94 includes the flange 84 extending radially outward from the base 94 relative to the central longitudinal axis 88. An opening 96 (not visible in FIGS. 3 and 4) extends into the base 94 through the end 90. In some embodiments, a cap (not shown) is provided for covering at least a portion of the end 90 of the connector housing 40 when the cable connector 30 is not mated with the mating connector 28, for example to protect the mating interface 34.

In the exemplary embodiment, the central longitudinal axis 88 of the connector housing 40 extends approximately perpendicular to the central longitudinal axis 65 of the cover 50, such that the cable connector 30 is a right angle connector. Alternatively, the central longitudinal axis 88 of the connector housing 40 extends at any other non-perpendicular angle relative to the central longitudinal axis 65 of the cover 50, such as, but not limited to, approximately parallel to the central longitudinal axis 65, an oblique angle relative to the central longitudinal axis 65, and/or the like.

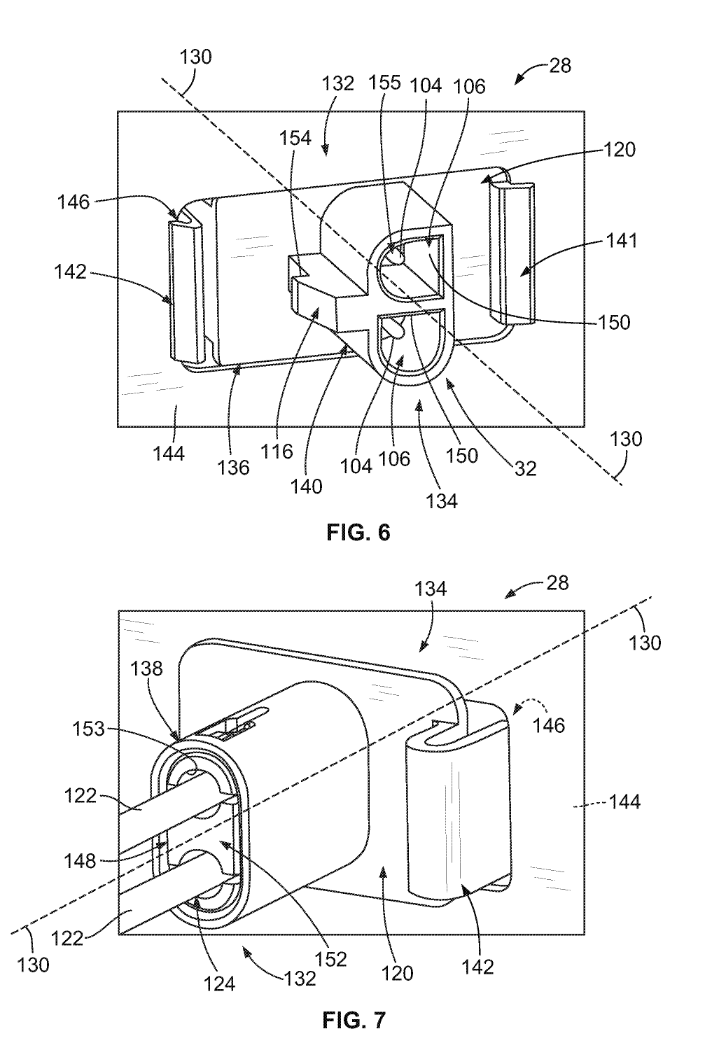

A pair of extensions 98 extends outwardly from the base 94 along the central longitudinal axis 88. Each extension 98 extends a length from the base 94 to a free end 100. Each extension 98 includes a contact cavity 102 (not visible in FIG. 5) extending into the extension 98 through the free end 100. The contact cavities 102 communicate with the opening 96 that extends through the base 94. As described above, each connector contact 42 terminates an end 46 of a corresponding one of the electrical wires 36. The contacts 42 and the electrical wire ends 46 are inserted into the opening 96 through the end 90 such that each connector contact 42 is held within the contact cavity 102 of a corresponding one of the extensions 98. When held within the corresponding contact cavity 102, the connector contacts 42 extend along the mating interface 34 for mating with a corresponding mating contact 104 (FIGS. 6 and 7) of the mating connector (FIGS. 1, 6, and 7). A positioning member 108 (not visible in FIG. 3) holds the connector contacts 42 within the connector housing 40. In the exemplary embodiment, the positioning member 108 includes a base 109 and a plurality of contact barrels 111 (only visible in FIG. 4) that extend outwardly from the base 109. The base 109 is received within the opening 96 at the end 90 of the connector housing 40 such that the contact barrels 111 extend into corresponding ones of the contact cavities 102. The connector contacts 42 extend through corresponding openings 113 (only visible in FIG. 5) within the base 111 and the contact barrels 111 such that mating ends 115 of the connector contacts 42 extend outwardly from the contact barrels 111 into the corresponding contact cavities 102. Optionally, the base 109 of the positioning member 108 seals the opening 96 at the end 90 of the connector housing 40.

In the exemplary embodiment, the extensions 98 define plugs of the mating interface 34 that are each configured to be received within a corresponding receptacle 106 (FIGS. 6 and 7) of the mating connector 28. Alternatively, one or more of the extensions 98 defines a receptacle that is configured to receive a plug (not shown) of the extension 140 (FIG. 6) and/or another portion of the housing 120 (FIGS. 6 and 7) of the mating connector 28. Although two extensions 98 are shown, the connector housing 40 may include any number of extensions 98 for holding any number of connector contacts 42. Moreover, in the exemplary embodiment each of the connector contacts 42 defines a receptacle contact that is configured to receive the corresponding mating contact 104 therein. Alternatively, one or more of the connector contacts 42 defines a pin or plug that is configured to be received within a receptacle (not shown) of the corresponding mating contact 104.

Each extension 98 optionally includes one or more keying features 110 to facilitate mating the cable connector 30 with the mating connector 28 in a desired relative orientation. For example, the keying features 110 may prevent the cable connector 30 from being mated with the mating connector 28 in an opposite relative polarity. In addition or alternative to the keying features 110, the connector housing 40 may include any other keying features, such as, but not limited to, one or more keying extensions (not shown) that extends outwardly from the base 94 along the central longitudinal axis 88 adjacent or within the mating interface 34, and/or the like.

The connector housing 40 includes one or more optional latching members 112. In the exemplary embodiment, each of the latching members 112 includes a window 114 that extends outwardly from the base 94. Each window 114 functions as a hook that is configured to engage a latching member 116 (FIGS. 6 and 7) of the mating connector 28 for holding the connectors 28 and 30 together when mated. In addition or alternative to the latching members 112 and/or the windows 114, the connector housing 40 may include any other structure, means, latching arrangement, and/or the like for holding the connectors 28 and 30 together when mated. Although two latching members 112 are shown, the connector housing 40 may include any number of the latching members 112 for cooperation with any number of latching members 116 of the mating connector 28.

Referring now to FIGS. 3 and 4, as described above, the connector housing 40 is rotatably held by the cover 50 for rotation relative to the cover 50. Specifically, the flange 84 of the connector housing 40 is received within the groove 82 within the end 66 of the cover 50 to hold the connector housing 40 to the cover 50. The flange 84 is movable within the groove 82 to enable rotation of the connector housing 40 about an axis of rotation 118 (not shown in FIG. 3) relative to the cover 50. Rotation of the connector housing 40 about the axis of rotation 118 may make it easier to move the extensions 98 of the cable connector 30 into the desired relative orientation with the mating connector 28. For example, if the connector housing 40 was not rotatable relative to the cover 50, a stiffness of the electrical cable 38 may make it difficult to move the extensions 98 into the desired relative orientation with the mating connector 28. Moreover, and for example, if the connector housing 40 was not rotatable relative to the cover 50, a stiffness of the electrical cable 38 may fatigue and/or damage the cable connector 30 and/or the electrical cable 38 when the cable connector 30 is mated with the mating connector 28 (FIGS. 1, 2, 6, and 7). In some embodiments, a bearing (not shown) may be operatively connected between the flange 84 and the groove 82 to facilitate rotation of the connector housing 40 relative to the cover 50.

FIG. 6 is a front perspective view of an exemplary embodiment of the mating connector 28. FIG. 7 is a rear perspective view of the mating connector 28. In the exemplary embodiment, the mating connector 28 includes a mating housing 120 and a pair of the mating contacts 104 (not visible in FIG. 7). As described above, the mating connector 28 is electrically connected to one or more electrical components (not shown) of the junction box 14 (FIGS. 1 and 2). In the exemplary embodiment, the mating contacts 104 of the mating connector 28 are each electrically connected to one or more electrical components of the junction box 14 via a corresponding electrical wire 122 (not visible in FIG. 6). Alternatively, the mating contacts 104 of the mating connector 28 are directly electrically connected to an electrical component of the junction box 14, such as, but not limited to, a circuit board (not shown) and/or the like. Each electrical wire 122 extends from an end 124 (not visible in FIG. 6) that is terminated by, and thus electrically connected to, a corresponding one of the mating contacts 104 and an opposite end (not shown) that is terminated by, and thus electrically connected to, one or more electrical components of the junction box 14.

In the exemplary embodiment, each electrical wire 122 includes one or more strands of an electrical conductor (not shown) that is surrounded by an insulating layer 126. Although two electrical wires 122 and two mating contacts 104 are shown, the mating connector 30 may include any number of mating contacts 104 for terminating any number of electrical wires 122.

The mating housing 120 extends a length along a central longitudinal axis 130 from an end 132 to an opposite end 134. The mating interface 32 (not visible in FIG. 7) of the mating connector 28 includes the end 134 of the mating housing 120. The mating housing 120 is configured to separabely mate with the cable connector 30 (FIGS. 1 and 3-5) at the mating interface 32. The mating housing 120 includes a base 136, a contact barrel 138 (not visible in FIG. 6) extending outwardly from the base 136 along the central longitudinal axis 130, and an extension 140 extending outwardly from the base 136 along the central longitudinal axis 130 in an opposite direction to the contact barrel 138. The contact barrel 138 includes the end 132, while the extension 140 includes the end 134. The mating interface 32 includes the extension 140. In some embodiments, a cap (not shown) is provided for covering at least a portion of the end 134 of the mating housing 120 when the mating connector 28 is not mated with the cable connector 30, for example to protect the mating interface 32.

Referring now to FIGS. 1, 2, 6, and 7, the mating housing 120 is held by the housing 24 (FIGS. 1 and 2) of the junction box 14 within an opening 26 (FIGS. 1 and 2) of the junction box housing 24. In the exemplary embodiment, the base 136 of the mating housing 120 includes one or more lips 141 and/or one or more latches 142 for connecting the mating housing 120 to the junction box housing 24. The lip 141 engages a surface 144 of the junction box housing 24. The latch 142 includes a resilient hook 146 that engages the junction box housing 24 to facilitate holding the mating housing 120 to the junction box housing 24. In addition or alternative to the lip 141, the latch 142, and/or the hook 146, the mating housing 120 may be held by the junction box housing 24 using any other type of arrangement, structure, means, connection type, fasteners, and/or the like, such as, but not limited to, a snap-fit, an interference fit, using a clip, using threaded fastener(s), and/or the like.

Referring now to FIGS. 6 and 7, a cavity 148 (not visible in FIG. 6) extends into the contact barrel 138 and the base 136 through the end 132. The extension 140 includes a pair of the receptacles 106 (not visible in FIG. 7) extending into the extension 140 through the end 134. The receptacles 106 communicate with the cavity 148 that extends through the contact barrel 138 and the base 136. As described above, each mating contact 104 terminates an end 124 of a corresponding one of the electrical wires 122. The mating contacts 104 and the electrical wire ends 124 are inserted into the cavity 148 through the end 132 such that each mating contact 104 is held within the corresponding receptacle 106. When held within the corresponding receptacle 106, the mating contacts 104 extend along the mating interface 32 for mating with the corresponding connector contact 42 (FIGS. 3-5) of the cable connector 30 (FIGS. 1 and 3-5). An optional positioning member 152 (not visible in FIG. 6) holds the mating contacts 104 within the mating housing 120. The positioning member 152 is received within the cavity 148 at the end 132 of the mating housing 120. The mating contacts 104 extend through corresponding openings 153 within the positioning member 152 such that mating ends 155 (not visible in FIG. 7) of the mating contacts 104 extend into the corresponding receptacles 106. Optionally, the positioning member 152 seals the cavity 148 at the end 132 of the mating housing 120.

In an alternative embodiment, the extension 140 includes one or more pins or plugs (not shown) configured to be received within a receptacle (not shown) of the cable connector 30. Although two receptacles 106 are shown, the mating housing 120 may include any number of receptacles 106 for holding any number of mating contacts 104. Moreover, in the exemplary embodiment each of the mating contacts 104 defines a pin or plug contact that is configured to be received within the corresponding connector contact 42. Alternatively, one or more of the mating contacts 104 defines a receptacle that is configured to receive a pin or plug (not shown) of the corresponding connector contact 42.

Each receptacle 106 optionally includes one or more keying features 150 (not visible in FIG. 7) to facilitate mating the mating connector 28 with the cable connector 30 in a desired relative orientation. For example, the keying features 150 may prevent the cable connector 30 from being mated with the mating connector 28 in an opposite relative polarity. In addition or alternative to the keying features 150, the mating housing 120 may include any other keying features, such as, but not limited to, one or more keying extensions (not shown) extending into the corresponding receptacle 106, and/or the like.

The mating housing 120 includes one or more of the optional latching members 116 (not visible in FIG. 7). In the exemplary embodiment, each of the latching members 116 includes a ledge 154 that extends outwardly from the extension 140. Each ledge 154 is configured to engage a corresponding one of the latching members 112 (FIGS. 3-5) of the cable connector 30 for holding the connectors 28 and 30 together when mated. In addition or alternative to the latching members 116 and/or the ledges 154, the mating housing 120 may include any other structure, means, latching arrangement, and/or the like for holding the connectors 28 and 30 together when mated. Although two latching members 116 are shown, the mating housing 120 may include any number of the latching members 116 for cooperation with any number of latching members 112 of the cable connector 30.

Although shown as electrically connecting a junction box 14 to a light fixture 12, the electrical cable 38 and the connector assembly 16 are not limited thereto. Rather, the electrical cable 38 and the connector assembly 16 may electrically connect any types of electrical components together. In some alternative embodiments, the electrical cable 38 and the connector assembly 16 electrically connect two junction boxes together. Moreover, the electrical cable 38 and the connector assembly 16 are not limited to transmitting electrical power between electrical components, but rather may additionally or alternatively transmit electrical data signals, optical power, optical data signals, and/or the like between any types of components. The connector assembly 16 is not limited to connecting a cable to another type of component (i.e., not a cable), but rather may directly connect two cables together or two non-cable components together. Furthermore, the connector assembly 16 is not limited for use with an armored cable, but rather may be used with unarmored cables.

The embodiments described and/or illustrated herein may provide a separable interface between an armored cable and another component. The embodiments described and/or illustrated herein may provide an armored cable that can be connected to another component without being hardwired to the other component. The embodiments described and/or illustrated herein may provide a connector terminating the end of a cable that may be more easily orientated relative to a mating connector.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the description and illustrations. The scope of the subject matter described and/or illustrated herein should therefore be determined with reference to the appended claims, along with the full scope of equivalents to which such claims are entitled. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

WHAT IS CLAIMED IS:

1. A connector and armored cable assembly, said assembly comprising:
an armored cable comprising an electrical wire; and
a connector comprising:
a connector housing having a mating interface, the connector housing being configured to mate with a mating connector along the mating interface, the mating interface being a separable interface such that the connector housing is separable from the mating connector at the mating interface after the connector housing and the mating connector have been mated together; and
a connector contact held by the connector housing, the connector contact being configured to engage a mating contact of the mating connector, the connector contact being electrically connected to the electrical wire of the armored cable.

2. The assembly according to claim 1, wherein the armored cable comprises an armored jacket, the armored jacket being mechanically connected to the connector.

3. The assembly according to claim 1, wherein the armored cable comprises a cable end, the connector comprising a cover holding the connector housing, the cable end of the armored cable being held by the cover.

4. The assembly according to claim 1, further comprising the mating connector, the connector housing and the mating connector being separable at the mating interface after the connector housing and the mating connector have been mated together.

5. The assembly according to claim 1, wherein the connector housing comprises a base and an extension extending outwardly from the base, the extension defining at least a portion of the mating interface, the connector contact being held within the extension.

6. The assembly according to claim 1, wherein the connector comprises a cover that holds the connector housing, the connector housing being rotatable relative to the cover.

7. The assembly according to claim 1, further comprising a light fixture, the armored cable electrically connecting the light fixture to the connector.

8. The assembly according to claim 1, further comprising the mating connector, the connector contact being separable from the mating contact of the mating connector after the connector contact and the mating contact have been engaged together.

9. The assembly according to claim 1, further comprising the mating connector and a junction box electrically connected to the mating connector.

10. The assembly according to claim 1, wherein the armored cable is configured to be electrically connected to an electrical component, using the connector, without being hardwired to electrical component.

11. The assembly according to claim 1, further comprising a light fixture, the armored cable electrically connecting the light fixture to the connector, wherein the light fixture is a fixed light fixture.

12. A connector for terminating the end of an electrical wire, said connector comprising:
a cover;
a housing held by the cover, the housing comprising a mating interface configured to mate with a mating connector, wherein the housing is rotatably held by the cover such that the housing is rotatable about an axis of rotation relative to the cover; and
a connector contact held by the housing, the connector contact being configured to engage a mating contact of the mating connector, the connector contact being configured to terminate the end of the electrical wire.

13. The connector according to claim 12, wherein the cover comprises a groove, the housing comprising a base having a flange received within the groove, the flange being movable within the groove to enable rotation of the housing relative to the cover.

14. The connector according to claim 12, wherein the housing comprises a base and an extension extending outwardly from the base, the extension defining at least a portion of the mating interface, the connector contact being held within the extension.

15. The connector according to claim 12, wherein the cover comprises a cavity, the cover being configured to hold a portion of at least one of the electrical wire and a cable that includes the electrical wire within the cavity.

16. The connector according to claim 12, wherein the cover comprises an interior surface defining a cavity, the cover being configured to hold a portion of at least one of the electrical wire and a cable that includes the electrical wire within the cavity, the cover comprising an extension extending outwardly from the interior surface into the cavity, the extension being configured to engage the cable to hold the portion of the cable within the cavity.

17. The connector according to claim 12, further comprising a cable, the cable including the electrical wire, the end of the electrical wire being terminated by the connector contact.

18. The connector according to claim 12, further comprising an armored cable., the armored cable including the electrical wire, the end of the electrical wire being terminated by the connector contact.

19. The connector according to claim 12, further comprising the electrical wire and a light fixture, the connector contact terminating the end of the electrical wire, the electrical wire being electrically connected to the light fixture, wherein the light fixture includes a fixture housing configured to be mounted on at least one of a wall, a floor, and, a ceiling of a building.

20. The connector according to claim 12, further comprising the electrical wire and a light fixture, the connector contact terminating the end of the electrical wire, the electrical wire being electrically connected to the light fixture, wherein the light fixture is a fixed light fixture.
